(19) United States
(12) Patent Application Publication
(10) Pub. No.: US 2008/0125059 A1
(43) Pub. Date: May 29, 2008

(54) PUSH-TO-TALK (PTT) CONTACT GROUP EVENT MANAGEMENT SYSTEM AND METHODS

(75) Inventors: CHARLES P. SCHULTZ, NORTH MIAMI BEACH, FL (US); JOSE C. LACAL, BOYNTON BEACH, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/738,991

(22) Filed: Apr. 23, 2007

Related U.S. Application Data
(60) Provisional application No. 60/867,334, filed on Nov. 27, 2006.

(51) Int. Cl. H04B 1/38

(52) U.S. Cl. 455/90.2

(57) ABSTRACT

A method and system for PTT management includes a PTT server (100) and a plurality of PTT devices (110) associated with the members of a PTT group (120) via a wireless network (130). The PTT server can include, or be coupled to, a mass storage device storing a database of member information (106) and a schedule (105). The stored schedule can use a scheduling application or module used to define the order of activities by each member of the PTT group to participate, to assign a time for an activity of each member, or to enter other information associated with the PTT group event. The member information can include contact information, task sign-on/sign-off information, current network status information, current availability information, alternative availability information, and request information. The plurality of devices is used to maintain contact and coordinate activities among the members of the PTT group.

### CROSS REFERENCE TO RELATED APPLICATIONS

This application claims the benefit of U.S. Provisional Patent Application No. 60/867,334, filed Nov. 27, 2006, the entire contents of which are incorporated by reference herein.

### FIELD

This invention relates generally to mobile devices, and more particularly to a system and methods for managing activities among members of a push-to-talk (PTT) group.

### BACKGROUND

Many types of events are based on the coordinated sequential activities of individuals in a group. For example, prayer chains and prayer circles consist of a number of individuals who have agreed to maintain a constant prayer for a cause over an extended period of time. In operation, each member prays during a set period of time, such that at least one member is praying at all times, with minimal or no interruption, over a period of time. However, there are several challenges involved in the execution of such types of events.

First, coordination of individual activities at separate locations can be an issue. For example, a problem in executing a prayer circle or chain is maintaining a continual prayer throughout the necessary period without an interruption. One solution is having all the individuals involved in a single room to perform the prayer, so that each member knows when the other has started or completed his prayer; however, such a solution is impractical and inconvenient, especially in a modern busy and mobile society. Another solution has generally been the use of a prayer schedule to assign participants a specific time slot to allot for the prayer. However without actual knowledge that a participant began his prayer on time or that the prayer was even performed, it is unknown to the prayer group whether or not the prayer indeed has been continuous. Therefore, drawing up a schedule is generally insufficient in such types of activities.

Second, management of scheduling problems can also be an issue. For example, another problem facing prayer circles or chains is that individuals assigned to a slot in a schedule may not be able to timely contact other members of the prayer group to make alternate arrangements when a conflict arises. Although in many cases an individual may aware of the conflict in advance, in many other cases the continuity of the prayer event is broken because individual is called away immediately and there is simply not enough time to contact others in time to arrange for someone to start or continue the prayer. One solution is to maintain more than one individual praying during each time slot, but often such a solution can be impractical and/or redundant. Another solution is to have the individual contact a prayer leader upon notice of an immediate conflict, but even so, the continuity of the prayer will be significantly interrupted as a prayer leader may require an extended amount of time to locate another member of the group to take the individual's place.

Third, organization of such activities can be an issue. For example, organizing prayer circles or chains in a highly mobile society can be problematic. In general, it is difficult to create a prayer schedule when only some of the members of the group can be contacted, especially when a prayer request calls for immediate action on the part of the group. Normally, the prayer group is started with only the members of the group who are available and others will either not participate or will be added later to the schedule. However, in many cases individuals who are traveling or are otherwise unavailable at the time of the request often wish to participate and would do so if given the chance. A solution is a pre-determined schedule could be maintained for prayer “emergencies”, but a schedule still limited in that action can only be taken it a member of a prayer group has notice of the start of the event. Furthermore, especially in large groups, providing notification to members of a group can be difficult. One solution to such issues involved in planning and managing such activities has been the use of modern telecommunications devices. Paging systems have been used to automatically notify participants, but such systems are only for informing users of activities and do not permit interaction when conflicts arise. Text messaging, wireless phones, and push-to-talk systems allow one individual to instantly connect to others, but if a scheduling conflict arises, such systems merely notify the members of the group as to the conflict, and do not suggest or provide any solutions. Therefore, even though advanced communication means allow group members to contact each other instantly across the globe; an affirmative step is still required on the part of an individual to coordinate individual activities such that these types of coordinated group events successfully run with limited or minimal interruption.

Therefore, what are needed are systems and methods that automatically coordinate, manage and organize activities comprising a coordinated series of acts by individuals in a pre-defined communications group. Such a system should synchronize the activities of all members of a group to allow them to perform these activities at the appropriate time in the event. Furthermore, such a system should also allow a group to organize an event instantly without having to personally contact all members. Additionally, such a system should dynamically respond to the availability of members, allowing for reassignment of activities automatically in order to maintain integrity of the event by ensuring that an activity of the event is performed at an appropriate time by at least one member of the group.

### SUMMARY OF THE INVENTION

In a first embodiment, a method of managing activities among members of a push-to-talk (PTT) group during a PTT contact group event is provided that includes the steps of: accessing a list or a database of member information associated with each member of a PTT group (where the member information includes contact information), creating a schedule comprising one or more activity slots assigned to one or more of the members of the PTT group, searching the schedule for at least one member of the PTT group assigned to a current activity slot, searching the schedule for at least one member of the PTT group assigned to a next activity slot, and retrieving contact information associated with the member of the PTT group assigned to the next activity slot and sending a notification at a completion of the current activity slot to the member of the PTT group assigned to the next activity slot, where the sent notification comprises notice to member of the PTT group assigned to the next activity slot that the next activity slot has begun.

In a second embodiment, a method of managing activities among members of a push-to-talk (PTT) group during a PTT contact group event is provide that includes the steps of: accessing a database of member information and searching for at least a first member of a PTT group having active request information (where the database of member information associated with each member of the PTT group comprises contact information and request information) and accessing the database of member information, retrieving contact information associated with one or more other members of the PTT group, and sending a notification to the one or more others member of the PTT group, where the sent notification includes a request to initiate the PTT contact group event.

In a third embodiment, a push-to-talk (PTT) server having a management module for managing activities among members of a PTT group during a PTT contact group event is provided which can include a transceiver coupled to the management module. The management module can include logic for: supervising a schedule comprising one or more activity slots assigned to one or more of the members of the PTT group for at least one member of the PTT group assigned to a current activity slot and at least one member of the PTT group assigned to a next activity slot; logic for retrieving contact information associated with the at least one member of the PTT group assigned to the next activity slot; and logic for sending a notification at a completion of the current activity slot to the at least one member of the PTT group assigned to the next activity slot, where the sent notification comprises notice to the at least one member of the PTT group assigned to the next activity slot that the next activity slot has begun.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. The word “exemplary” is used herein to mean “serving as an example, instance, or illustration.” Any embodiment or design described herein as “exemplary” is not necessarily to be construed as preferred or advantageous over other embodiments or designs.

### BRIEF DESCRIPTION OF THE DRAWINGS

FIG. 1 is an exemplary diagram of the elements for a PTT contact group in accordance with an embodiment of the invention.

FIG. 2 is an exemplary general flow for management of a PTT contact group event schedule in accordance with an embodiment of the invention.

FIG. 3 is an exemplary flow for management of a current activity slot in accordance with an embodiment of the invention.

FIG. 4 is an exemplary flow for management of a future activity slot in accordance with an embodiment of the invention.

### DETAILED DESCRIPTION OF THE DRAWINGS

With reference now to the various figures in which like elements are identically numbered throughout, a description of the various embodiments of the present invention will now be provided. While the invention is discussed in the context of a prayer group, it can be appreciated that the invention can include numerous modifications from the presented embodiments.

Embodiments in accordance with the invention can provide a solution for creating and managing activities of an event requiring coordination of the actions of a group of individuals. Such events can be planned or unplanned, but generally require execution using a schedule of assignments for the members of a group to perform a series of activities over a period of time, sequentially and with minor or no interruption between activities. In accordance with one embodiment of the invention, a push-to-talk (PTT) server is configured to manage the schedule and coordinate the activities of the various members of a prayer group.

While the invention will be described with respect to its use in coordinating prayer groups, it should be appreciated that the invention has application in any field where similar coordination of activities and participants is required. The features of the illustrated arrangement of invention are particularly well adapted for prayer groups as the invention allows members to manually or automatically schedule, coordinate, and manage the activities of individuals in the prayer group. However, the invention is suited for other activities, including non-prayer group activities, where careful coordination and management of sequential activities of tasks is sought. In other embodiments, the invention could be adapted for any type of social or business group in which it is desired to automatically provide a system or method ensure that at least one member of a group is performing an appropriate task at an appropriate time.

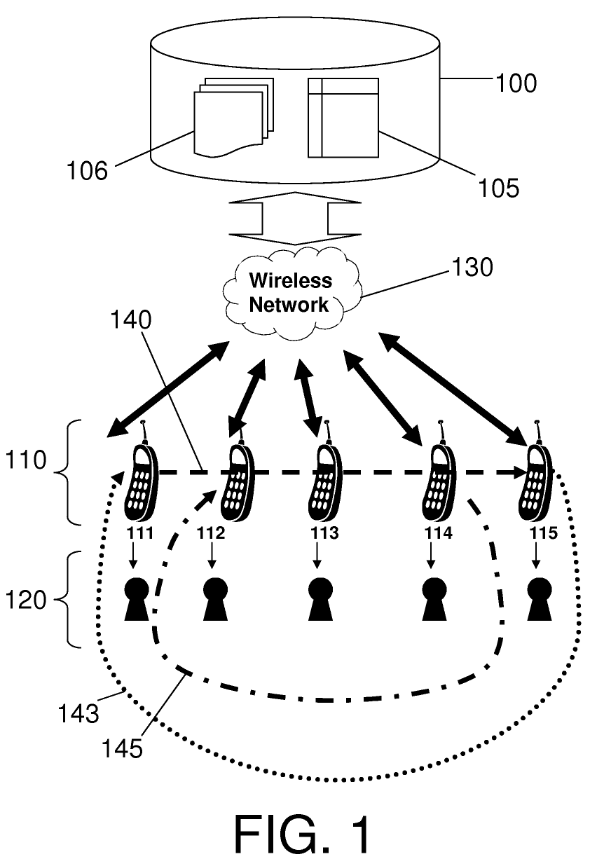

FIG. 1 shows an exemplary schematic of the various components used in the various embodiments of the invention. As illustrated, the exemplary schematic includes a PTT server 100 and a plurality of PTT devices 110, associated with the members of the PTT group 120, coupled to the PTT server through a wireless network 130. In the exemplary schematic, the PTT server 100 can include, or be coupled to, a mass storage device storing a database of member information 106. The PTT server 100 can also include or be coupled to a mass storage device storing a schedule 105. While the illustrative schematic in FIG. 1 illustrates the database 106 and the schedule 105 as two separately stored objects in the PTT server 100, it can be appreciated that a single stored object may be used to store both the member information and the schedule information. For example, a relational database could be provided to store both member and schedule information as different, but related, tables of the relational database.

In the various embodiments, the stored schedule 105 can be constructed using a scheduling application or module that be used to define the order of activities by each member of the PTT group 120 to participate, to assign a time for an activity of each member of the group PTT group 120 participating, or to enter other information associated with the PTT group event. Such an application may be implemented using a standalone program or through a client interface having access to the stored schedule 105. It can be appreciated such an application may be configured to operate on personal digital assistants, laptop computers, desktop computers, smart phones, or essentially any computing device capable of sending, receiving, and displaying data. Furthermore, it can be appreciated that access to the stored schedule 105 can be provided locally or through a network connection. It can also be appreciated that such an application could be accessed at any time, allowing the information in the stored schedule 105 to be modified at any time by the user of the scheduling application.

In the various embodiments, the database of member information 106 can be similarly constructed using a database application or module that stores information associated with each member of the PTT group 120. In the various embodiments, the information can include, but is not limited to: contact information, task sign-on/sign-off information, current network status information, current availability information, alternative availability information, and request information. It can be appreciated that for each of these fields, the type, content, and quantity of information stored can vary according to the particular needs of the members of a PTT group 120 participating in an event.

In some embodiments, at least some entries in the database of member information 106 may be automatically populated as members are added to a PTT group by a PTT server 100 configured to handle PTT groups. However, in some embodiments it is contemplated that an application may be used or even required to enter the necessary information manually. Such an application may be implemented using a standalone program or through a client interface having access to the database of member information 106. It can be appreciated such an application may be configured to operate on personal digital assistants, laptop computers, desktop computers, smart phones, or essentially any computing device capable of sending, receiving, and displaying data. Furthermore, it can be appreciated that access to the database of member information 106 can be provided locally or through a network connection. It can also be appreciated that such an application could be accessed at any time, allowing entries in the database of member information 106 to be modified at any time by the user of the database application.

In the illustrated schematic in FIG. 1, the plurality of devices 110 is used to maintain contact and coordinate activities among the members of the PTT group. In the illustrated embodiment, the plurality of devices 110 comprises a plurality of PTT devices operating over a PTT-capable wireless network coupled to the PTT server 100. PTT communications allow a PTT enabled device to contact another PTT device and transmit information without having to necessarily enable two-way communications. This is advantageous for the various embodiments, as messages and notifications can be configured to be sent instantly to other members of the group 120 or the PTT server 100 as PTT signals.

In the various embodiments, the plurality of devices 110 may be configured to provide various types of information to the PTT server 100. In the various embodiments, the PTT devices 110 may be configured to transmit PTT device status information, such as network status and identifying information.

In some embodiments, the plurality of devices 110 can also be configured to transmit a signal to initiate a group event. The use of PTT is advantageous, as PTT systems can be configured to activate a connection instantly or nearly instantly among a large group of individuals. By using a PTT system, each of the devices can be configured to allow selection of not only groups to contact by PTT, but also selection of activities to start using the PTT system. For example, when a member of a PTT group 120 wishes to start an activity by PTT, a PTT signal sent to the PTT server 100 can be configured to signal to begin the PTT group event, rather than signaling a request for communication. In some embodiments, signaling the start of the PTT group event can comprise the PTT server connecting all users at the same time. In other embodiments, additional PTT signals from the PTT devices 110 could be configured to notify the PTT server 100 of other types of events occurring other that the start of a PTT group event. In some embodiments the PTT devices 110 could signal the members of the PTT group 120, using a distinctive “chirp” or other audio or visual signals, to signal the start of a PTT group event.

In some embodiments, the plurality of devices 110 can also be configured to transmit additional status information specific to the PTT group 120 to the PTT server 100. For example, the devices 110 may be configured to provide a special network status identifier associated with the PTT group 120. In some embodiments, this special status identifier can be configured to signal to the other members of the PTT group 120 that although an individual is currently unavailable for an activity, the member wishes to be informed of PTT group events. In other embodiments, the special status identifier can comprise request information. For example, in a prayer group, the special status could indicate that the member of the group is in a mental state requiring prayer or that he otherwise has a special need for prayer. Alternatively, the request could indicate that the member of the group is currently in prayer and that additional praying members are welcome or either not welcome. It can be appreciated that such status information may be locally in the interface of one of the PTT devices 110 associated with an member of the PTT group 120 or by sending a message to the PTT server 100 to modify the status information in the database of member information. In other embodiments, it is contemplated that the PTT devices 110 can be configured to show status information for all members of the PTT group 120, allowing other members of the PTT group 120 to monitor availability and request information for each of the members of the PTT group 120. It can be appreciated that such status information could be provided on each of the PTT devices 110 by varying text, color, or other indicia or status identifier associated with a member of the PTT group.

In some embodiments, the plurality of devices 110 can also be configured to send and receive information specific to the PTT group event. In other embodiments, the devices 110 may be configured to send and receive textual or graphical information regarding the current activity. For example, text of a prayer or a religious symbol can be displayed by each of the plurality of devices. In another example, instructions for properly executing a prayer, such as text, position, or direction, can also be received and displayed by the devices 110.

In other embodiments, the plurality of devices 110 can also be configured to send and receive information specific to a task assigned to a user in the PTT group 120. For example, task sign-on/sign-off information may be sent by each of the devices 110 when a member of the group starts and ends his assigned task. In such embodiments, the signal could be sent after setting special identifier in one of the devices 110 or by a specially configured PTT signal transmitted by the devices 110, as previously discussed.

In the various embodiments, the plurality of devices 110 communicates through the wireless network 130 with the PTT server 100. In the various embodiments, the PTT server 100 can comprise a computing device configured to manage the typical PTT communication functions of a PTT server 100, including, but not limited to, initiating PTT contacts, maintaining PTT contact groups, and managing PTT conversations. However, a PTT server 100 in accordance with the present invention can be further configured to perform additional tasks.

In some embodiments, the PTT server 100 can be configured to monitor the status of all devices 110 in the PTT contact group 120. In the various embodiments, the PTT server 100 can collect information on the current network status of each of the devices 110 and also any additionally configured information for the PTT contact group 120. The PTT server 100 can also be configured to monitor for any PTT signal from any of the devices 110 and to differentiate between requests to contact a group and requests to start a group event or signal any other event. The PTT server 100 can also be configured to automatically update the database 106 with the current information retrieved from each one of the devices. For example, if one of the devices 110 is showing a status identifier requesting a prayer, an entry in the database of member information 106 associated with an individual associated with the device can be populated by the PTT server 100 to indicate that an active prayer request for the individual exists. In such embodiments, the database 106 is continually updated with the latest information from each of the devices 110.

In other embodiments, the PTT server 100 can be configured to determine when to start a PTT group event. In the various embodiments, a PTT group event can be initiated at a predetermined time or upon occurrence of a pre-determined event. In the various embodiments, pre-determined events in a prayer group can include, but are not limited to, a PTT request from one of the PTT devices 110 to start a prayer event or a status indicator on one of the PTT devices 110 showing a prayer need by an individual. In one embodiment, a distinctive “chirp” or other audio or visual signals, on a PTT device 110 could be configured to notify each member of the PTT group 120 when it is their turn to pray.

In some embodiments, if the PTT server 100 has determined that a prayer group should start, the PTT server 100 can be configured to manage the schedule of participants. The PTT server 100 can also be further configured to transmit a signal to one of the devices 110 associated with a current activity slot, in order to inform a member that it is his turn to participate. The PTT server 100 can also be configured to determine if the members assigned to the current and future activity slots are available. In some embodiments, the PTT server 100 can be further configured to automatically assign or request a replacement member for an activity slot, if the assigned member is unavailable or cannot be reached. In such embodiments, the PTT server 100 can be further configured to update a schedule 105 for an event, in order to reflect the changes automatically made by the PTT server 100. For example, a prayer group schedule would be automatically updated by the PTT server 100 to show the newly assigned participant for a current slot, if the previously assigned participant became unavailable. In some embodiments, information regarding participation by the various members of the PTT group can be stored on a database or sent to a database or user for review.

In some embodiments, The PTT server 100 could also be further configured to transmit a message to one or more members. In some embodiments, the messages can comprise schedule updates. In other embodiments, the messages could include information or instructions for the current or requested activity and past or present participant information. For example, if a prayer request is made by one of the members of the PTT group 120. After the prayer is executed by the PTT group 120, a message could be sent to the requester showing who participated in the prayer and when they participated.

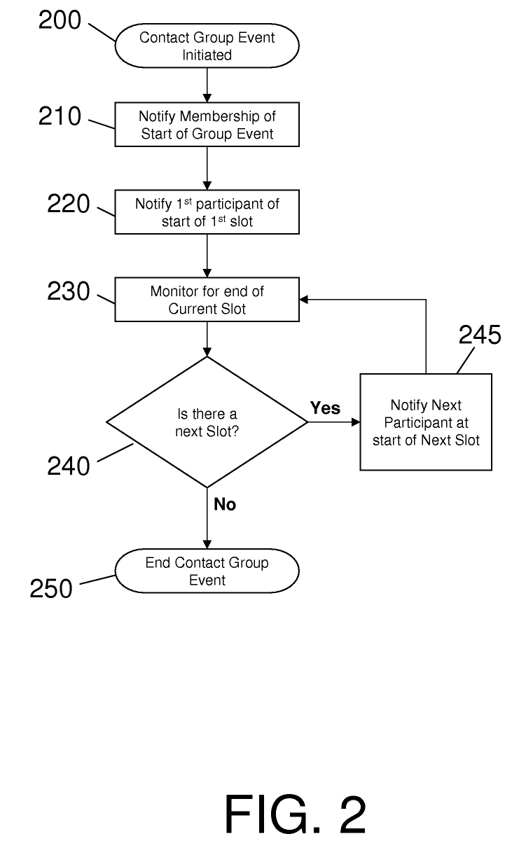

An exemplary process flow for a PTT 100 server handling a PTT contact group event is shown in FIG. 2. Such a flow is advantageous as it allows present and future participants to be reminded of their assigned activity slots throughout the event. First, a contact group event is initiated, step 200. In the various embodiments, as previously described, contact group event may be initiated in any number of ways. For example, a prayer circle or chain may agree upon a predetermined time to begin the prayer. In another example, a prayer request from one member may also initiate automatically initiate the event. In other embodiments, a prayer request may be submitted by one member of the PTT group; however, a PTT group event is not initiated until another member of the PTT group manually initiates the PTT group event. In some embodiments, the prayer request may be general or specific and the requester can provide additional information in response to a request from another member of the PTT group 120 through the PTT device. In some embodiments, the PTT devices may be configured to provide an emotional state of a member of the PTT group. An emotional state may be provided by biometrics or by user input of an emotional state into a PTT device. In the various embodiments, biometric data can comprise monitored data from the body of user, including but not limited to voiceprint, fingerprint, or heart rate data, and associate such data with an emotional state. In such embodiments, when the PTT server detects specific emotional states, the PTT server can be configured to automatically initiate a PTT group event. In the various embodiments, it is contemplated that the initiation of a group event can be based on a pre-determined time or other signaling event or on demand by one of the members of the contact group 120.

Once the group event is initiated, the PTT server 100 can be configured to contact all the members of the group, in order to inform them of the event at step 210. In the various embodiments, the contact may be made using visual or audio means. In some embodiments, the typical “chirp” associated with contacting a PTT device may be replaced with an alternate audio signal, which indicates to the members of the group that a group event has begun. In other embodiments the PTT server 100 may be configured to send a textual or graphical message to the members of the PTT group 120, relating the information regarding the PTT group event and notifying them it has begun. In some embodiments, at the same time notification is going out to the members of the PTT group 110, the PTT server 100 may begin polling the devices 110 associated with the members 120 to verify availability and keep track of participants. In some embodiments, the PTT devices 110 can be further configured to allow members to opt out of participating in an event. Using any opt out information and availability information, the PTT 100 server can be configured to automatically being monitoring and altering the schedule 105 for the initiated event. In some embodiments, throughout the PTT group event, the PTT call can be maintained and all members of the PTT group 120 can be kept in continuous audio contact.

Additionally, upon start of the contact group event, the PTT server 100 can also be configured to find a schedule 105 associated with the contact group or the contact group event, in order to locate the first participant. Once the first participant is identified, the PTT server 100 can access the database of member information 106, retrieve contact information for the first participant, and contact the first participant, informing him of the start of the first activity slot of the event, step 220. In the various embodiments, the contact may be made using visual or audio means. In some embodiments, the typical PTT “chirp” may be replaced with an alternate audio signal, which indicates to a member of the group 120 that a slot has begun. In other embodiments, the PTT server 100 may be configured to send a textual or graphical message to the member of the PTT group 120 assigned to the current slot, relating the information regarding the current slot and notifying him that the current slot has begun. It can also be appreciated that in some embodiments, the notice indicating the start of a slot and associated information can be sent to more than one participant, allowing other members to track the progress of the activity.

Once the current slot has begun, the PTT server 100 can monitor for the end of the current slot, step 230. In some embodiments, slots terminate automatically upon release of the PTT button on a user's PTT device. In some embodiments, slots terminate automatically upon the passage of a predetermined amount of time. In other embodiments, slots and even the entire activity could end upon occurrence of a terminal event. For example, in a prayer group for an individual with an illness, the resolution of the illness could be used to signal the termination of the prayer group. It can be appreciated that a termination signal could be sent to the PTT group 120, using a PTT signal or other means of contacting the PTT server 100. In other embodiments, slot could also terminate based on the cessation of activities by the member assigned to the current slot. For example, in embodiments where task sign-in/sign-off functionality is available, a current slot could end when the member “signs off”. Alternatively, if the member assigned to the current slot never “signs in” or informs the PTT server 100 that he cannot or will not participate, the PTT server 100 could be configured to automatically terminate the current slot as well. Similarly, if the PTT server 100 is configured to monitor for current or network availability, a slot could be terminated if contact is lost with a PTT device associated with a member or the PTT server 100 was never able to locate the device at the start of the slot. However the invention is not limited in this regard and other methods of terminating a slot or can event could be used in the various embodiments of the invention.

At the end of the slot, the PTT server 100 can be configured to determine if a next slot exists, step 240. If a next slot exists, the PTT server 100 can be configured to access the schedule 105, identify the next participant and retrieve contact information from the database 106 for the next participant. Afterwards, notification, as discussed for the first participant, can be sent to the next and subsequent participants, step 245. The PTT server 100 would then monitor for the end of the next slot, step 230, determine if a subsequent slot exists, step 240, and notify a subsequent participant. In the various embodiments, steps 230, 240, and 245 continue repeating until no future slots exist, step 250. Furthermore, it can be appreciated that a schedule 105 in accordance with the present invention made be linear or circular. For example, prayer groups are often organized as chains or circles. In the case of chains, as shown in FIG. 1, the order of participants might be 111, 112, 113, 114, and 115, as shown by the dashed line 140 in FIG. 1. After the slot allotted for 115, the chain is complete and the prayer group ends. However in the case of circles, after the slot allotted for 115 is complete, the schedule loops, as shown by the dotted line 143, back to the first member 111 and the cycle begins again. In such embodiments, the circle would continue repeating until some terminal event, as previously discussed, occurs.

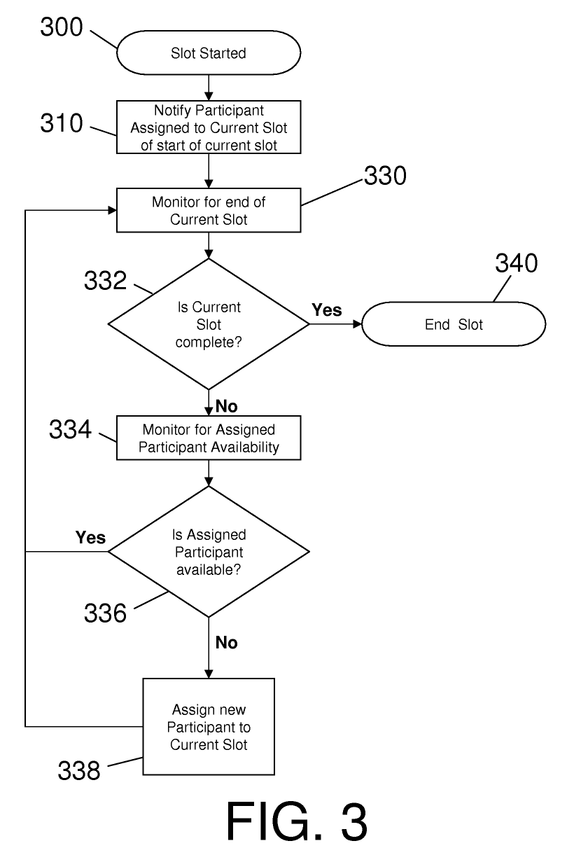

In the various embodiments, the PTT server 100 can also be configured to automatically adjust the schedule to account for absences or unavailability on the part of members during a current slot, as shown in the exemplary process flow in FIG. 3. This arrangement is advantageous as it allows the PTT server 100 to automatically manage the current slot to ensure event continuity. As previously discussed, a slot begins and notification is sent to the participant assigned to the current slot, steps 300, 310. Also as previously discussed, the PTT server can be configured to monitor for an event to terminate a slot, step 330. However, in some embodiments, it can be unpractical to end the current slot and inform the next participant. For example, in schedules assigned based on time slots, the next participant may not be prepared or may be unavailable to perform if the previous slot ends prematurely. To handle such circumstances, the PTT server 100 may be configured to recruit a new participant to complete the current time slot.

In the exemplary flow, if the PTT server determines that the current slot is not complete, step 332, the PTT server 100 monitors the availability of the currently assigned participant, step 334. In the various embodiments, as long as the currently participant is available the current slot remains unchanged, steps 330-336. Alternatively, in embodiments with task sign-on/sign-off functionality, the PTT server may continue monitoring to assure that the currently assigned member is still signed in. In other embodiments, the PTT server 100 may simply monitor for to make sure the PTT device of the current participant is still active. In the various embodiments, if the currently assigned participant becomes unavailable for some reason, the PTT server 100 can be configured to automatically recruit a replacement, step 338. In some embodiments, the schedule 105 could be configured to include one or more alternate participant for a current slot. In these embodiments, the alternate would be informed by the PTT server 100 and instructed to sign in or otherwise assume control of the current slot. In other embodiments, one or more members showing current availability on the network could be automatically assigned to or automatically requested to assume control of the current slot by the PTT server 100. In the exemplary flow, once a member is assigned and remains active until the end of the current slot, the slot terminates normally, as previously described. In some embodiments, when a reassignment is made, the PTT server 100 can be further configured to update the schedule 105 to reflect the changes. In other embodiments, the PTT 100 server could also be configured to automatically trade of positions of participants in the schedule when such reassignment to a current slot is made. In other embodiments, the PTT server 100 could be configured to automatically send out a message to the members of the PTT group 120, informing them of the change.

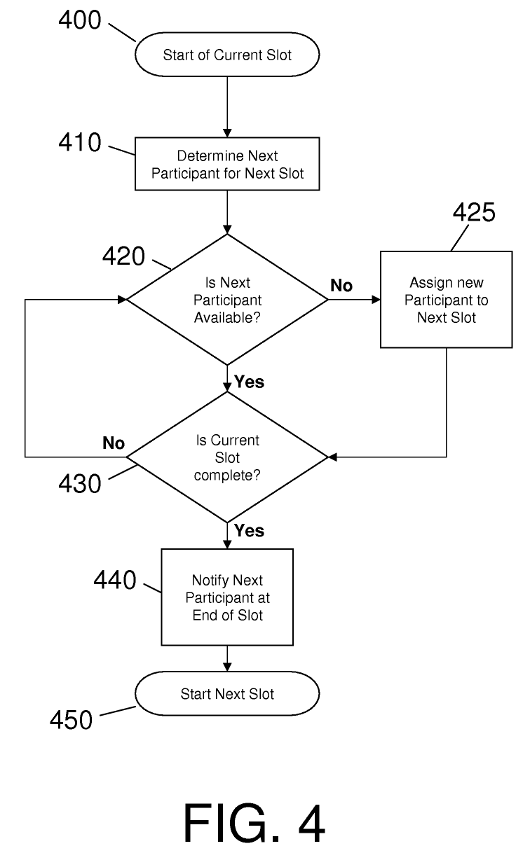

In the various embodiments, the PTT server can also be configured to automatically adjust the schedule to account for absences or unavailability on the part of members during a next or future slot, as shown in the exemplary process flow in FIG. 4. As in the embodiment in FIG. 3, such an arrangement is advantageous as it allows the PTT server 100 to automatically manage the future slots to ensure event continuity. As previously described, a current slot can begin, step 400. In some embodiments, the PTT server 100 can be configured to determine the assigned participant for the next slot, step 410, and determine if the next participant is available, step 420. In some embodiments, the PTT 100 server can be configured to make this determination by monitoring the status of the PTT device associated with the next assigned participant. In other embodiments, the PTT server 100 can be configured to make this determination by querying the PTT device associated with the next assigned participant and making the determination of availability only if the query is acknowledged by the next participant. It can be appreciated that in some embodiments, the query can comprise a request to the next participant of whether or not he will be available for the next slot. In the various embodiments, the next participant could acknowledge using a PTT signal or by sending a message using other means provided for on the PTT device.

When the next assigned participant is unavailable or acknowledges future unavailability, the PTT server 100 can be configured to automatically recruit a replacement, step 425. In embodiments where the schedule is configured to include one or more alternate participants for a next slot, the alternate would be informed by the PTT server 100 of his new assigned slot. In other embodiments, one or more members showing current availability on the network could be automatically assigned to or automatically requested to assume control of the next slot. In some embodiments, when a reassignment is made, the PTT server 100 can be further configured to update the schedule 105 to reflect the changes. In other embodiments, the PTT 100 server could also be configured to automatically trade of positions of participants in the schedule when such reassignment to a future slot is made. In other embodiments, the PTT server 100 could be configured to automatically send out a message to the members of the PTT group 120, informing them of the change. In the exemplary flow, once a member is assigned to the next slot, at the beginning of the next slot, step 450, the next assigned participant is notified of the start of the slot, step 440, as previously described. It can be appreciated that in some embodiments, the PTT server 100 can be configured to automatically continue to monitor for availability of members for a next slot until the current slot is complete, steps 420, 430.

It can be appreciated that the process flows in FIGS. 2-4 are for illustrative purposes and that the steps included therein could be performed in a different order than the one presented. It can also be appreciated that in the various embodiments, the invention could be configured to combine any or all of the steps illustrated in FIGS. 1-3 or any other steps disclosed herein. In some embodiments, monitoring of current and future availability may be combined to automatically limit the activity to a smaller group and still maintain continuity. For example, referring to FIG. 1, after a prayer group is initiated, a PTT server 100 may determine that a first device 111 and a last device 115 are unavailable for current or future slots. In such an instance, the PTT server 100 can be automatically configured to modify the schedule to include only devices 112, 113, and 114 in the schedule. In the case of a prayer chain, the prayer would then end after a prayer by the member associated with device 114. In the case of a prayer circle, the slot for member associated with device 114 is completed, the PTT server would assign the member associated with device 112 to the next slot and the circle would loop, as shown by the dash-dot line 145, to device 112. In some embodiments, however, the PTT server 100 could continue to monitor for availability of devices 111 and 115 and place them back in the schedule when available. In some embodiments, such as a prayer chain, previously unavailable member could be added to the end of the schedule automatically by the PTT server 100, to extend the prayer time for the prayer group and include those members. As previously discussed a notice of such changes could be sent to the members of the PTT group 120 by the PTT server 100. However, the invention is not limited in this regard and other schemes for including and excluding available and unavailable member of the PTT group in accordance with the present invention are possible.

It is also contemplated that the events being coordinated by the present invention can include one or more assigned slots wherein one or more of the members of the PTT group 120 speak to the other members. In embodiments with a time based schedule, the PTT server 100 could be configured to automatically cutoff a current speaker after the current slot is complete, keeping the schedule on time and allowing others to being speaking. In other embodiments, the PTT server 100 could be configured to automatically extend the current slot and modify the start of length future slots to accommodate for the extra time utilized by the current participant.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors. Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of managing activities among members of a push-to-talk (PTT) group during a PTT contact group event, the method comprising the steps of:
accessing a list or a database of member information associated with each member of a PTT group, wherein the member information comprises contact information;
creating a schedule comprising one or more activity slots assigned to one or more of the members of the PTT group;
searching the schedule for at least one member of the PTT group assigned to a current activity slot;
searching the schedule for at least one member of the PTT group assigned to a next activity slot; and
retrieving contact information associated with the at least one member of the PTT group assigned to the next activity slot, and sending a notification at a completion of the current activity slot to the at least one member of the PTT group assigned to the next activity slot, wherein the sent notification comprises notice to the at least one member of the PTT group assigned to the next activity slot that the next activity slot has begun.

2. The method of claim 1, wherein the member information further comprises task sign-on status information, wherein the completion of the current activity slot occurs when a task sign-on status information associated with the at least one member of the PTT group assigned to the current activity slot is inactive for a pre-determined length of time.

3. The method of claim 1, wherein the schedule further comprises a length of time associated with each of the one or more activity slots, wherein completion of the current activity slot occurs when the length of time associated with the current activity slot has passed.

4. The method of claim 3, wherein the member information further comprises task sign-on status information, wherein a task sign-on status information associated with the at least one member of the PTT group assigned to the current activity slot remains active past the end of the current time period, wherein completion of the current activity slot occurs if the task sign-on status information associated with the at least one member of the PTT group assigned to the current activity slot is inactive a pre-determined length of time.

5. The method of claim 3, wherein the task sign-on status information associated with the at least one member of the PTT group assigned to the current activity slot is inactive a pre-determined length of time prior to the end of the current activity slot, wherein the member information further comprises current network status information, and the method further comprising the steps of:
accessing the database of member information and checking the current network status information associated with at least another member of the PTT group;
accessing the database of member information, retrieving contact information associated with at least another member of the PTT group having active current network status information; and
sending a message to the at least another member of the PTT group having active current network status information, wherein the message comprises a request for the at least another member of the PTT group having active current network status to assume control of the current activity slot.

6. The method of claim 5, wherein the database of member information further comprises alternative availability information, wherein alternative availability information comprises availability of a member of the PTT group during at least one of the one or more activity slots, and the method further comprising the steps of:
accessing the database of member information and identifying at least one other member of the PTT group showing current availability, wherein showing current availability comprises having alternative availability information matching the current activity slot; and
accessing the database of member information, retrieving contact information associated with the at least one other member of the PTT group showing current availability; and
sending a message to the at least one other member of the PTT group showing current availability, wherein the sent message comprises a request for the at least another member of the PTT group showing current availability to assume control of the current activity slot.

7. The method of claim 1, wherein a PTT contact group event is automatically initiated or terminated upon occurrence of a pre-defined initiation event and wherein a PTT contact group event is automatically terminated upon occurrence of a pre-defined terminal event.

8. The method of claim 1, wherein the schedule operates as a recurrent schedule.

9. The method of claim 1, wherein the member information further comprises current network status information, and the method further comprising the steps of:
accessing the database of member information and checking the current network status information associated with at least another member of the PTT group;
accessing the database of member information and retrieving contact information associated with at least another member of the PTT group having inactive current network status information; and
sending a message to the at least another member of the PTT group having inactive current network status information, wherein the message comprises current PTT contact group event information.

10. The method of claim 7, further comprising the steps of:
establishing a PTT call among the members of the PTT group and maintaining the PTT call until the occurrence of a terminating event.

11. A method of managing activities among members of a push-to-talk (PTT) group during a PTT contact group event, the method comprising the steps of:
accessing a database of member information and searching for at least a first member of a PTT group having active request information, wherein the database of member information associated with each member of the PTT group comprises contact information and request information;
accessing the database of member information, retrieving contact information associated with at least a second member of the PTT group, and sending a notification to the at least second member of the PTT group, wherein the sent notification comprises a request to initiate the PTT contact group event.

12. The method of claim 11, wherein the member information further comprises availability information, and the step of accessing, retrieving, and providing further comprising the steps of:
retrieving the current status information associated with each member of the PTT group and;
selecting the at least second member of the PTT group, wherein the at least second member of the PTT group includes each member of the PTT group showing current availability, wherein showing current availability comprises having active availability information.

13. The method of claim 12, wherein the at least second member of the PTT contact group is selected sequentially, wherein the sequential selection occurs according to a schedule comprising one or more activity slots assigned to one or more of the members of the PTT group.

14. The method of claim 12, wherein the PTT contact group event has been initiated, further comprising the steps of:
sending a message to at least one unselected member of the PTT group, wherein the sent message comprises initiated PTT contact group event information.

15. The method of claim 11, wherein the sent notification includes an option for the at least second member of the PTT group to send a response to the at least first member of the PTT group.

16. The method of claim 11, further comprising the steps of:
sending a message to the at least first member of the PTT group, wherein the sent message comprises participation information regarding the PTT contact group event initiated in response to the request to initiate the PTT contact group event, wherein the participation information comprises a listing of one or more members of the PTT group participating in the PTT group event.

17. The method of claim 11, wherein the request information comprises request information based on an emotional state of at least one member of the PTT contact group.

18. The method of claim 17, wherein the emotional state is determined based on one or more biometric readings of the at least one member of the PTT contact group exceeding a threshold value.

19. A push-to-talk (PTT) server having a management module for managing activities among members of a PTT group during a PTT contact group event, comprising:
a transceiver coupled to the management module, wherein the management module comprises logic for:
supervising a schedule comprising one or more activity slots assigned to one or more of the members of the PTT group for at least one member of the PTT group assigned to a current activity slot and at least one member of the PTT group assigned to a next activity slot; and
retrieving contact information associated with the at least one member of the PTT group assigned to the next activity slot; and
sending a notification at a completion of the current activity slot to the at least one member of the PTT group assigned to the next activity slot, wherein the sent notification comprises notice to the at least one member of the PTT group assigned to the next activity slot that the next activity slot has begun.

20. The server of claim 19, the logic for sending a notification further comprising logic for:
monitoring task sign-on status information for the at least one member of the PTT group assigned to the current activity slot; and
determining completion of the current activity slot, wherein completion of the current activity slot occurs when the task sign-on status information for the at least one member of the PTT group is inactive for a pre-determined length of time.

21. The server of claim 19, the logic for managing the schedule further comprising logic for:
retrieving task sign-on status information for the at least one member of the PTT group assign to the current activity slot;
monitoring current network status of at least one other member of the PTT group; and
reassigning the current activity slot to the at least one other member of the PTT group showing active current network status information when the task sign-on status information for the at least one member of the PTT group is inactive.

22. The server of claim 21, wherein the at least one other member of the PTT group being monitored is assigned as an alternate for the current activity slot.

23. The server of claim 19, the management module further comprising logic for:
initiating a PTT contract group event upon the occurrence of a pre-defined initiation event; and
terminating the PTT contact group event upon the occurrence of a pre-defined termination event.

24. The method of claim 23, the management module further comprising logic for:
establishing a PTT call among the members of the PTT group and maintaining the PTT call until the occurrence of a terminating event.
